(19) United States
(12) Patent Application Publication
(10) Pub. No.: US 2014/0199969 A1
(43) Pub. Date: Jul. 17, 2014

(54) MOBILE DEVICE AND METHOD FOR CELLULAR ASSISTED DEVICE-TO-DEVICE COMMUNICATION

(71) Applicants: Kerstin Johnsson, Palo Alto, CA (US); Shilpa Talwar, Los Altos, CA (US); Nageen Himayat, Fremont, CA (US)

(72) Inventors: Kerstin Johnsson, Palo Alto, CA (US); Shilpa Talwar, Los Altos, CA (US); Nageen Himayat, Fremont, CA (US)

(21) Appl. No.: 13/993,548

(22) PCT Filed: Dec. 16, 2011
(86) PCT No.: PCT/US11/65638

§ 371 Date: Aug. 23, 2013

Related U.S. Application Data
(60) Provisional application No. 61/515,721, filed on Aug. 5, 2011.

(51) Int. Cl. H04W 76/02; H04W 12/06

(52) U.S. Cl. CPC H04W 76/023; H04W 12/06
USPC 455/411

(57) ABSTRACT

Systems and methods for configuring device-to-device (D2D) wireless communications are generally disclosed herein. One example embodiment includes a method of transmitting mobile station information, security context information, and radio resource management information to mobile stations over a primary wireless network in order to establish and operate D2D connections among the mobile stations using a secondary wireless network. Another example embodiment includes a wireless network base station having a D2D connection facilitator configured to determine configuration information for the D2D connections among the mobile stations, and a transmitter configured to transmit the configuration information to the mobile station.

### PRIORITY CLAIM

This application claims priority under 35 U.S.C. 119(e) to U.S. Provisional Patent Application Ser. No. 61/515,721, filed Aug. 5, 2011, which is hereby incorporated by reference herein in its entirety.

### TECHNICAL FIELD

Embodiments pertain to wireless communications. Some embodiments relate to the use of device-to-device (D2D) communication techniques implemented within wireless networks and services.

### BACKGROUND

D2D communications between devices may be used for various purposes, including increasing the reuse of licensed communication bands, or offloading data onto unlicensed communication bands. For example, resource-intensive multimedia traffic may be offloaded onto unlicensed band networks (such as a Wi-Fi network operating in accordance with IEEE standard 802.11-2007, or a Bluetooth network operating in accordance with a Bluetooth Special Interest Group standard) to reduce loading on resource-limited licensed band networks (such as 3G or 4G cellular phone networks).

However, the use of D2D communications has been hampered by a number of limitations. One limitation involves security considerations, and the need to define a “security context” between untrusted peers. Existing security techniques in D2D wireless networks typically rely on human intervention for setup, thus limiting D2D uses to manual configurations and a single user (or, at most, limited groups of users). Another limitation is the lack of “anytime/anywhere” access to rich content and services that peers can share with each other.

There is also a general need for improved efficiency of D2D data transfers, whether occurring over licensed or unlicensed communication bands.

### BRIEF DESCRIPTION OF THE DRAWINGS

FIG. 1 illustrates an example network configuration for D2D wireless network connectivity used in connection with various embodiments;

FIG. 2A illustrates a flow diagram of a sequence of operations to enable D2D connectivity between networked peers according to one example embodiment;

FIG. 2B illustrates a sequence of operations and communications between a base station and mobile stations to enable D2D connectivity according to one example embodiment;

FIG. 3 illustrates a flow diagram of a method performed by a base station for establishing a D2D communication network according to one embodiment;

FIG. 4 is a flow diagram illustrating a method performed by a mobile station for establishing a D2D communication network according to one embodiment; and

FIG. 5 illustrates a block diagram of an example machine upon which one or more embodiments can be implemented.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The following describes various system architecture configurations and signaling techniques that enable secure and efficient D2D connectivity and communication between wireless devices, including “strangers” or otherwise untrusted devices. The techniques described herein further enable D2D communications using one or more communication bands, including a combination of licensed and unlicensed wireless communication bands.

In one example embodiment where peer devices are connected to a cellular radio access network (RAN) (e.g., a 3G or 4G/LTE phone network), the cellular network may provide scheduled peer discovery periods during which devices can transmit and/or listen for advertisements from devices in their vicinity. After peer discovery, existing security and authentication limitations to D2D link establishments may be resolved by providing useful information to devices via their connections to a primary network, for example, their connections to a cellular RAN. Once the D2D link is established between the devices via a secondary network, configuration information may be communicated via the primary network to facilitate subsequent D2D communications between the devices. Therefore, in this configuration, connectivity with a primary network (e.g., a licensed cellular RAN) is used to facilitate connectivity with a secondary D2D network (e.g., an unlicensed band Wi-Fi or Bluetooth network, another unlicensed band ad-hoc network, or even a licensed band D2D network).

Providing D2D configuration information via a common network such as a cellular RAN enables a variety of D2D characteristics and operations to be configured, including: aiding in peer discovery and selection; automating peer authentication and link security establishment; enabling secure D2D connections between untrusted devices on the secondary D2D network; enabling D2D connectivity over the same network protocol as used by the primary network (e.g., a licensed band network); improving radio resource management of D2D communications; and providing “anytime/anywhere” access to rich content (e.g. from the Internet, or services provided by a phone system operator) for peer sharing, thereby motivating increased uses of D2D communications.

The techniques and system configurations described herein therefore may be used to automate peer authentication and security establishment for D2D connections on a secondary network using any number of network protocols or communication bands, whether unlicensed band D2D protocols such as Wi-Fi or Bluetooth, or licensed band D2D protocols. In further embodiments, the network protocol used by the secondary network may even be the same protocol as used by the primary network.

As further described herein, device communication with and use of radio resource management (RRM) information from the cellular RAN may assist with the coordination of the D2D link transmissions on the secondary network. This RRM information may be used in conjunction with various offloading strategies onto D2D connections to improve QoS and reduce interference for the primary network. Communication with and RRM information from the cellular RAN may also be used to improve the speed and accuracy of peer discovery and selection. The cellular RAN may also provide “anytime/anywhere” access to rich content that can be shared among peers over the D2D connections.

Also as further described herein, the communication and use of security context information from a trusted source such as a cellular RAN enables D2D connectivity to be securely and effectively deployed in public network settings, making connectivity available to more devices in more locations. Such security establishment may, for example, facilitate a cellular phone network to offload data traffic from a base station (BS) by allowing untrusted mobile station (MS) peers to communicate directly instead of routing traffic through the BS, thereby improving cellular system efficiency.

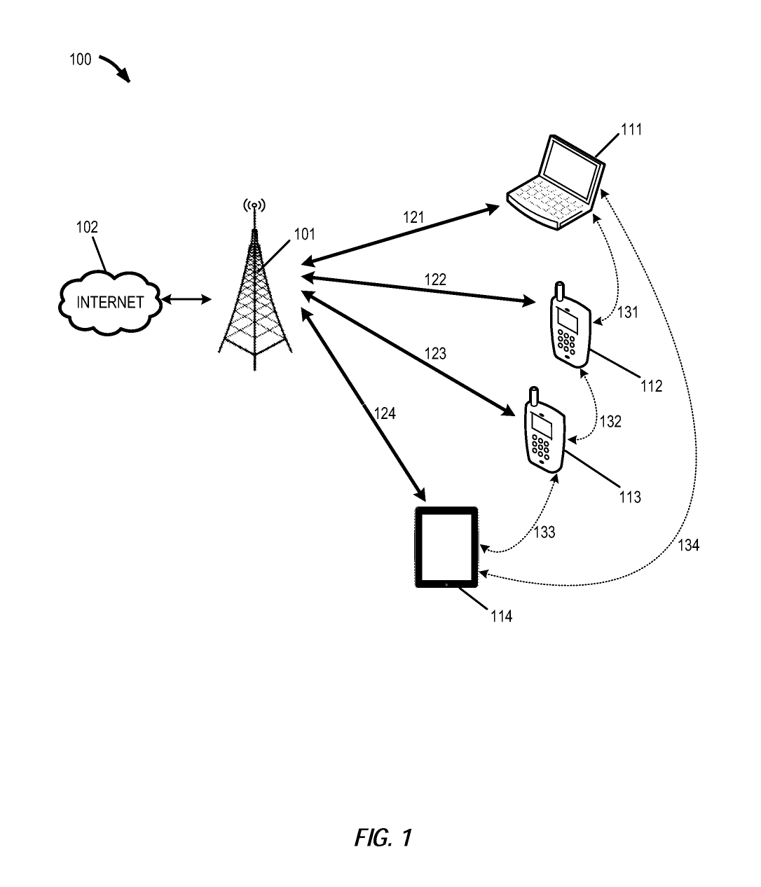

FIG. 1 provides an illustration of a wireless network architecture 100 enabling D2D communication between a plurality of devices (“peers”) on the wireless network according to one example embodiment. As illustrated, a BS 101 (e.g., provided in a cellular RAN), that may be connected to the Internet 102 or other public/wide-area network, communicates with various MS peers 111, 112, 113, 114 (e.g., a portable computer, smartphones, phone handsets, tablet computing devices, and like devices with network-capable user equipment) via primary network connections 121, 122, 123, 124, using a primary wireless network such as licensed cellular RAN (e.g., a network operating in accordance with a 3G/4G protocol).

Using the D2D configuration techniques described herein, the BS 101 may be may configured to provide or facilitate peer discovery, peer authentication and security, D2D radio resource management, and peer service content for secondary network D2D connections 131, 132, 133, 134 among the MS client peers 111, 112, 113, 114. The secondary network D2D connections 131, 132, 133, 134 may be configured to use a licensed spectrum, unlicensed spectrum, or both simultaneously for the D2D communications. (Further, in some embodiments, the primary wireless network and the secondary wireless network may share use of the frequency band).

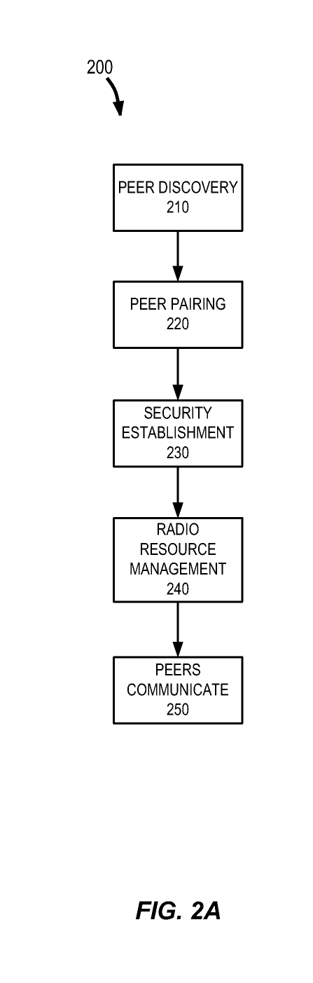

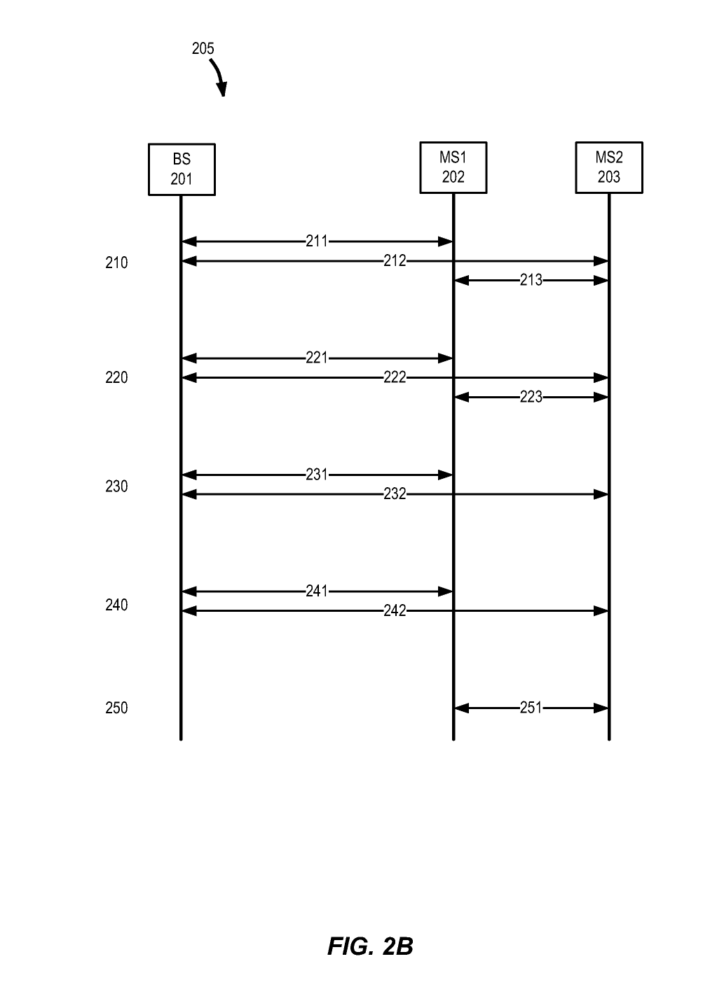

In connection with a D2D-enabled network architecture, the process of discovering, connecting, and communicating between devices may be configured in accordance with the example operation sequence 200 and communication sequence 205 illustrated in FIGS. 2A and 2B. FIG. 2A provides an overview of the operation sequence according to one example embodiment, including peer discovery (operation 210), peer pairing (operation 220), security establishment (operation 230), radio resource management (operation 240), and peer communication (operation 250). These operations are further described in reference to the various communication activities in the communication sequence 205 of FIG. 2B.

Specifically, FIG. 2B illustrates a series of BS and MS functions (e.g., performed by a BS 201 such as a cellular RAN) that enable D2D connectivity between MS1 202 and MS2 203 on the same or different band as the primary wireless network (whether a licensed or unlicensed band), and the flow of signaling associated with these functions.

First, in the peer discovery operation (210), peer devices in the network discover each other. The peer discovery operation may be conducted independently between the mobile stations MS1 202 and MS2 203, or with the help of the BS 201. The peer discovery operation may also be used to obtain mobile station information used in establishing the D2D connections among the peer devices. This may include a BS-to-MS exchange 211 and 212, a MS-to-MS exchange 213, or both types of exchanges, to relay information regarding channel qualities, availability for D2D connection, data content, etc.

Next, in the peer pairing operation (220), information is exchanged to determine which peer devices to connect. The peer pairing operation may be used to obtain further mobile station information used in establishing the D2D connections among the peer devices. This may include a BS-to-MS exchange 221 and 222, a MS-to-MS exchange 223, or both types of exchanges, to relay further information regarding channel qualities, availability for a D2D connection, data content, etc.

Next, in the security establishment operation (230), the BS 201 authenticates each of the peers (MS 1 202, MS2 203) and provides the peers with security context information used to secure D2D-communicated data transmissions between them. The BS-to-MS communication provided in BS-to-MS exchanges 231, 232 is used to provide peer authentication and establish a security context (e.g., specific authentication information) used for the D2D link.

Next, in the radio resource management operation (240), the BS 201 provides radio resource management functions for the D2D wireless network links, which may include scheduling, power control, ARQ/HARQ values, and the like. The BS-to-MS communication provided in BS-to-MS exchanges 241, 242 may be used therefore to coordinate radio resource management information with the various devices of the secondary wireless network in their respective D2D connections.

Finally, in the peer communication operation (250), the peers communicate with each other, such as through D2D communication link 251 between MS1 202 and MS2 203. This may also integrate with content communications from the BS 201 (not shown). For example, one or both peers may request content of the BS 201 to be shared between each other over the D2D communication link 251.

The D2D link may be established using D2D protocols on the licensed or unlicensed bands, and if the peers have the capability they can choose to establish and use both protocols at the same time. As would be understood, the purpose and utilization of the secondary wireless network D2D link may vary. It may be used for a variety of purposes, including boosting BS-to-MS throughput (e.g. an MS with better channel quality to the BS may be used to boost transmission and reception rates to/from the BS and another MS), offloading, or simple data sharing between peers.

In one example embodiment applicable to cellular networks, establishing cellular-assisted D2D communication between MS devices (e.g., client phones) is conducted in a series of stages, including: peer discovery and selection; peer authentication and D2D link security establishment; radio resource management for peer discovery and D2D link transmission; and content acquisition. Each of these stages is described in the following sections.

Peer Discovery and Selection

With the use of an unlicensed band (e.g., Wi-Fi or Bluetooth), devices can directly communicate with each other and discover each other independently. However, a discovery and selection process may be facilitated and improved through use of a cellular RAN that provides some degree of coordination. For example, if the BS operating in the cellular RAN knows the locations of MS devices in its cell with service content to share, it may broadcast (or multicast/unicast) this information along with a prescribed advertisement period for those MS devices to other devices in the cell that may want to access that content.

If devices only have access to the licensed band, the peer discovery process may be managed by the BS. In its simplest form, management may include the creation or allocation of resources to enable D2D peer discovery. For example, this may include the creation of a D2D “zone” in the wireless network frame structure during which devices can engage in peer discovery signaling (e.g., advertisements). A D2D zone is an allocation of resources in time and/or frequency for the specific purpose of D2D communication; no BS transmissions occur during this zone.

The BS may also be configured to aid a device in determining the best peer to connect to for a given purpose (e.g. device collaboration, content sharing, etc.) based on data it has collected over time from devices in its network.

Additionally, via device connections to a common network such as a cellular RAN, peers may be informed of potential matches in their area as well as discovery periods when they can locate each other. For example, the cellular RAN may provide connectivity information to MS1 indicating that MS2 is available for a D2D connection, or should be used to access or transmit certain data.

Security

With many existing techniques, unlicensed band D2D connections need to be secured manually. In other words, before devices can connect using an unlicensed band technology (e.g. via a Wi-Fi or Bluetooth D2D connection), someone (usually the owner of both devices) must create and secure the peer connection. This can be done by entering security information pertaining to the pending connection into both devices. Some security techniques such as “near field communication” may require that devices are “bumped” to establish security.

Regardless of the technique, securing peer devices with manual configuration requires human intervention. Thus, manual security configuration limits D2D use to devices that either belong to the same owner or to owners that know each other, while also requiring device users to invest the time to setup a security context between their devices.

To enable widespread use of D2D connectivity, particularly for offloading data from a cellular RAN to D2D networks and making D2D connections available to peer devices anytime/anywhere, there must be a security mechanism in place, accessible anytime and anywhere, that establishes trust between peers without human intervention. In one embodiment, such a security function is provided by the cellular RAN that each of the peer devices already subscribe to. Thus, the cellular RAN performs or establishes authentication of the peers and provides the security context for the connection between them.

In this model, peers must either belong to the same cellular RAN or to cellular RANs that have a “management agreement” in place. For example, if two devices have subscriptions with a particular cellular RAN (e.g. a mobile phone carrier), they are individually authenticated by that network. Then, if and when they discover each other and want to connect via an unlicensed band D2D protocol (e.g. Wi-Fi), they can request that the cellular RAN provide proof of authentication of the peer as well as a security context they can use to secure, privatize, or authenticate the data they will send over the unsecured, unlicensed band D2D protocol.

Radio Resource Management (RRM)

While unlicensed band D2D links can be managed solely by the devices, they may benefit from radio resource management provided by a cellular RAN. For example, if the D2D link employs Wi-Fi, the cellular RAN may provide a suggested schedule for the various D2D connections in its cell in such a way that contention for resources is minimized

When the D2D link resides on the licensed band, management by the cellular RAN is likely to be a requirement; however, the extent of this management can vary considerably. It may be as simple as creating a D2D zone in the frame structure or as complicated as dynamically creating the actual scheduling on each D2D link in the cell.

If devices connect via both the licensed and unlicensed bands, the amount of radio resource management required of the cellular RAN may increase. However, with the availability of both links, the network and/or peers can improve the quality of the D2D link by either employing both links simultaneously or by switching between them judiciously.

Content Acquisition

Most D2D connectivity today is between devices belonging to the same owner, with the content transmitted being generally personal or private data. Public content, such as commercial videos, movies, games, and other service data that would commonly be shared between “unrelated” devices generally requires that one or both devices have access to the internet at some point. While this can be provided via a wired link or unlicensed band access points, these avenues are significantly restricted by virtue of their limited offerings and fixed locations. To enable “rich content sharing” among devices anytime/anywhere, one or both devices must have access to long-range cellular RANs. Therefore, use of the presently described cellular RAN-facilitated connections may be used to facilitate the transfer of rich content among the D2D peers.

Example Device-to-Device Network Implementations

One implementation of the presently described techniques and configurations includes a method performed by a cellular RAN base station for configuring D2D wireless communications. In an example embodiment, this method includes: transmitting mobile station information to a plurality of mobile stations via a primary wireless network (e.g., a 4G LTE network), the mobile station information used to establish one or more D2D connections among the mobile stations via a secondary wireless network (e.g., a Wi-Fi D2D network); transmitting security context information to the mobile stations via the primary network, the security context information used to establish security in the D2D connections of the secondary wireless network; and transmitting radio resource management information to the mobile stations via the primary wireless network, the radio resource management information used to manage communications in the D2D connections of the secondary wireless network.

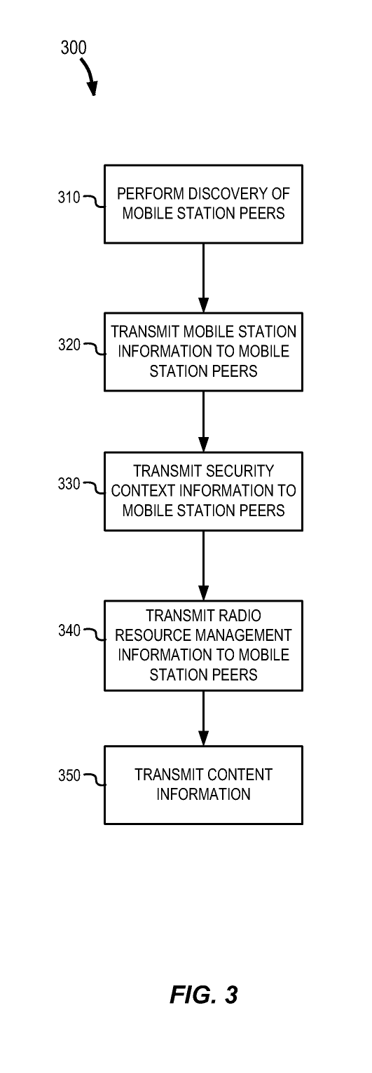

FIG. 3 provides an illustration of an example method 300 conducted at a cellular RAN base station for configuring D2D wireless communications according to one embodiment. This method may include the optional management of peer discovery by the base station (operation 310). This discovery may be conducted by one or more mobile stations autonomously or in conjunction with the base station.

Mobile station information may be transmitted to the mobile station peers (operation 320). Likewise, authentication and security context information may be transmitted to the mobile station peers (operation 330), and radio resource management information may be communicated to mobile station peers (operation 340). Content information such as the location of content among the peers then may be communicated to the mobile station peers (operation 350). In one configuration, content location information may instead be communicated directly among peers, so the content communications from the base station may be minimal.

Another implementation includes a cellular RAN base station configured for enabling D2D connections among its client mobile station nodes. This implementation may include a D2D connection facilitator and a transmitter. The D2D connection facilitator may be configured to obtain configuration information for D2D wireless connectivity among mobile stations in a secondary wireless network, including: mobile station information for establishing one or more D2D connections among the mobile stations; authentication and security context information for establishing security in the D2D connections among the mobile stations; and radio resource management information for managing peer discovery and D2D communications on the secondary wireless network. The transmitter may be configured to transmit the mobile station information, the authentication and security context information, and the radio resource management information in one or more transmissions to the mobile stations.

Another implementation includes a method performed by a mobile station for configuring D2D wireless communications. In an example embodiment, this method includes: processing mobile station information, authentication and security context information, and radio resource management information provided by a base station on a primary network; performing peer discovery; establishing one or more D2D connections between itself and one or more peer mobile stations on a secondary network based on the mobile station information; processing authentication information and establishing a security context within the one or more D2D connections based on the security context information; and communicating requested content via the D2D network.

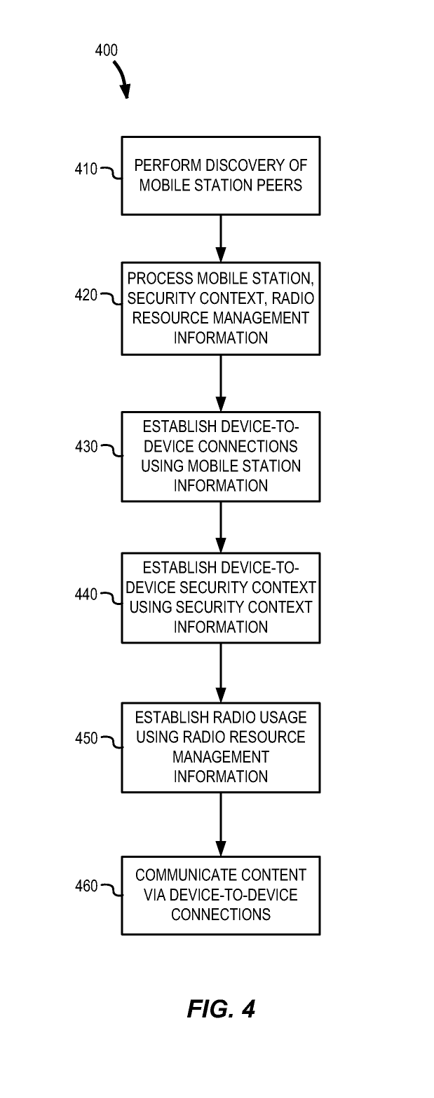

FIG. 4 provides an illustration of an example method 400 conducted at the mobile station for configuring D2D wireless communications according to one embodiment. This method begins with the discovery of mobile station peers (operation 410). This discovery may be performed with help of the base station.

Information related to the mobile station(s), authentication and security context, and radio resource management may be processed at the mobile station (operation 420). This information is used as appropriate to: establish D2D connections using the mobile station information (operation 430); process authentication information and establish security contexts in the D2D connections using the security context information (operation 440); and establish radio usage using radio resource management information (operation 450). Ultimately, the content may be communicated from the MS to one or more MS via the D2D connections (operation 460). Additionally, in one further embodiment, the mobile station information may also be used in connection with performing peer discovery of the mobile station peers (operation 410).

In further embodiments, the mobile station information includes information communicated directly from the one or more peer mobile stations via the secondary network. In other further embodiments, the method may include selecting which peer to connect to within the one or more peer mobile stations based on the mobile station information.

Another implementation includes a mobile station configured for performing D2D wireless communications. The mobile station may include a D2D connection component and a content communication component. The D2D connection component may be configured to receive and process mobile station information, authentication and security context information, and radio resource management information (such as provided by a base station on a primary network); establish one or more D2D connections between the mobile station and one or more peer mobile stations on a secondary network based on the mobile station information; and process authentication information and establish a security context within the one or more D2D connections based on the security context information. The content communication component may be configured to communicate (e.g., request, receive, and transmit) mobile station information (i.e., peer advertisements) and content among the various D2D connections and nodes of the D2D network.

Another implementation includes a wireless network (e.g., a cellular RAN) including a base station, a plurality of mobile stations, and a D2D connection facilitator configured to obtain configuration information for D2D connections and enable the D2D wireless connectivity among the mobile stations. In such an implementation, the D2D connection facilitator does not need to exclusively operate at the base station or mobile station, but may operate in connection with base station communications to the mobile stations via a primary network to facilitate D2D wireless connections via a secondary network. The D2D connection facilitator may include some or all of the previously mentioned communication establishment features of a base station. However, the D2D connection facilitator in some embodiments may be operated by a third party independently of both the base station and the mobile stations.

Although the previously described techniques and configurations are generally provided with reference to cellular RANs or the use of other networks operating with licensed network protocols, these techniques and configurations may also be applicable to variations of wireless communication networks, including wireless wide area networks, wireless local area networks, and wireless personal area networks. Further, the previously described techniques and configurations may be applied within any number of D2D, machine-to-machine, or peer-to-peer nodes, devices, and system configurations, and are not necessarily limited to the network architectures or terminology described herein.

Embodiments may be implemented in one or a combination of hardware, firmware, and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the BS or the MS may include one or more processors and may be configured with instructions stored on a computer-readable storage device.

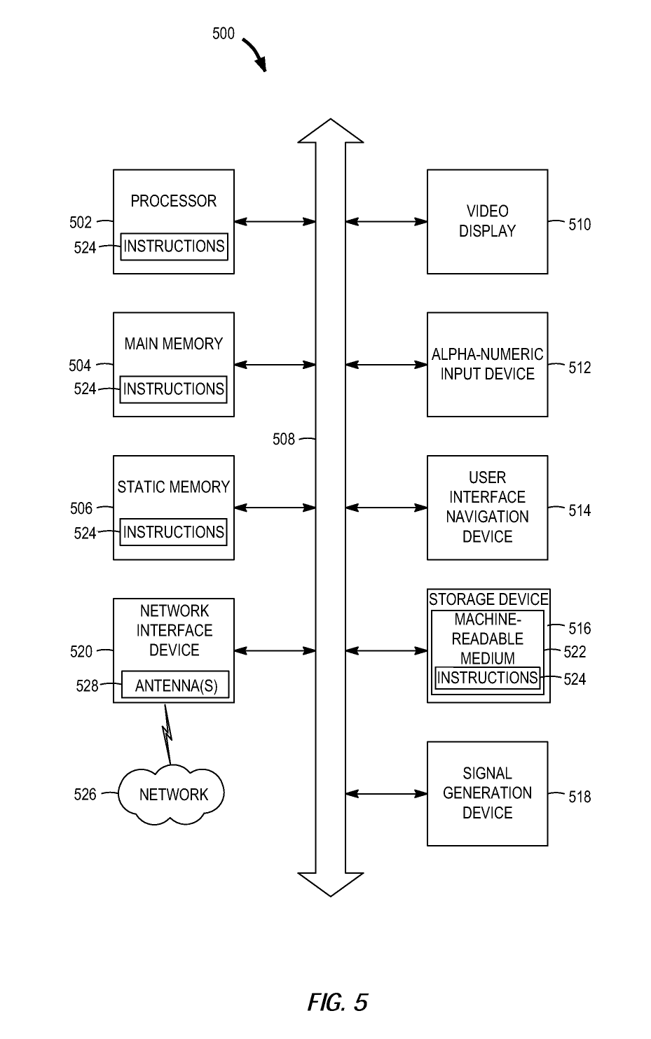

FIG. 5 is a block diagram illustrating an example machine upon which any one or more of the methodologies herein discussed can be run. In alternative embodiments, the machine operates as a standalone device or can be connected (e.g., networked) to other machines. In a networked deployment, the machine can operate in the capacity of either a server or a client machine in server-client network environments, or it can act as a peer machine in device-to-device (or distributed) network environments. The machine can be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 500 includes a processor 502 (e.g., a central processing unit (CPU), a graphics processing unit (GPU) or both), a main memory 504 and a static memory 506, which communicate with each other via a bus 508. The computer system 500 can further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are a touch screen display. The computer system 500 can additionally include a storage device 516 (e.g., a drive unit), a signal generation device 518 (e.g., a speaker), a network interface device 520 (which may include or operably communicate with one or more antennas 528, transceivers, or other wireless communications hardware), and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 can also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” can include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 524 may be further be transmitted or received over a communications network 526 using a wired or wireless transmission medium via the network interface device 520 utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., Wi-Fi, and 4G LTE/LTE-A or WiMax networks). The term “transmission medium” shall be taken to include any intangible medium that is capable of storing, encoding, or carrying instructions for execution by the machine, and includes digital or analog communications signals or other intangible medium to facilitate communication of such software.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. A method performed by a base station for configuring device-to-device wireless communications, comprising:
transmitting mobile station information to one or more mobile stations via a primary wireless network, the mobile station information used to establish one or more device-to-device connections on a secondary wireless network;
transmitting authentication and security context information to the mobile stations via the primary wireless network, the authentication and security context information used to authenticate peers and establish security for the device-to-device connections; and
transmitting radio resource management information to the mobile stations via the primary wireless network, the radio resource management information used to manage communications in the device-to-device connections.

2. The method of claim 2, wherein peer discovery is performed by the mobile stations to determine participation in the device-to-device connections of the secondary wireless network, and wherein previously acquired mobile station information is provided by the base station to assist with the peer discovery.

3. The method of claim 1, wherein the mobile station information includes one or more of channel qualities, availability for the device-to-device connection, and data content.

4. The method of claim 1, further comprising transmitting content information to the mobile stations via the primary wireless network, the content information used by the mobile stations to facilitate content transfers using the device-to-device connections of the secondary wireless network.

5. The method of claim 1, wherein the primary wireless network is a cellular radio access network (RAN), and wherein the base station operates within the cellular RAN.

6. The method of claim 1, wherein the secondary wireless network operates according to a standard from the IEEE 802.11 standards family.

7. The method of claim 1, wherein the primary wireless network and the secondary wireless network each communicate using a common network protocol, and wherein the radio resource management information includes information to allocate wireless resources in time or frequency for use of the common network protocol.

8. The method of claim 7, wherein the common network protocol is provided according to a 3GPP Long Term Evolution (LTE) or Long Term Evolution-Advanced (LTE-A) standard.

9. The method of claim 1, wherein the secondary wireless network is configured to conduct the device-to-device communications using a first wireless network protocol common to the primary wireless network and a second wireless network protocol not common to the primary wireless network.

10. The method of claim 1, wherein the primary wireless network is configured to communicate using a protocol in a licensed band, and wherein the secondary wireless network is configured to communicate using a protocol in an unlicensed band.

11. A wireless network base station, comprising:
a device-to-device connection facilitator configured to determine configuration information for device-to-device wireless connectivity among a plurality of mobile stations in a secondary wireless network, including:
mobile station information for establishing one or more device-to-device connections among the mobile stations;
authentication and security context information for authenticating peers and establishing security in the device-to-device connections; and
radio resource management information for managing peer discovery and communications in the device-to-device connections; and
a transmitter configured to transmit the configuration information in one or more data transmissions to the mobile stations.

12. The wireless network base station of claim 11, the transmitter further configured to transmit acquired mobile station information to aide in peer discovery on the secondary wireless network.

13. The wireless network base station of claim 11, wherein the mobile station information includes one or more of channel qualities, availability for the device-to-device connections, and data content.

14. The wireless network base station of claim 11, the transmitter further configured to transmit content information to the mobile stations via the primary wireless network, the content information used to facilitate content transfers among peers in the device-to-device connections of the secondary wireless network.

15. The wireless network base station of claim 11, wherein the wireless network base station operates as an access point for a cellular, radio access network (RAN), and wherein the one or more data transmissions to the mobile stations occur via the cellular RAN.

16. The wireless network base station of claim 15, wherein the primary wireless network operates in accordance with a 3GPP Long Term Evolution (LTE) or Long Term Evolution-Advanced (LTE-A) standard, and
wherein the secondary wireless network operates in accordance with an IEEE 802.11 standards family.

17. The wireless network base station of claim 11, wherein the primary wireless network and the secondary wireless network communicate using a common network protocol, and
wherein the radio resource management information includes information to allocate wireless resources in time or frequency for use of the common network protocol.

18. A mobile station configured to:
provide mobile station information to a base station;
receive peer mobile station information, peer authentication and security context information, and radio resource management information from the base station over a primary wireless network;
establish one or more device-to-device connections between the mobile station and one or more peer mobile stations in accordance with a device-to-device network communication technique based on the mobile station information; and
authenticate the one or more peer mobile stations using the authentication information and establish a security context within the one or more device-to-device connections based on the security context information.

19. The mobile station of claim 18 further configured to:
manage communications within the one or more device-to-device connections based on the radio resource management information; and
communicate the mobile station information and content to at least one other peer mobile station to allow exchange of mobile station information and content among the peer mobile stations in a device-to-device network.

20. The mobile station of claim 19 further comprising:
two or more antennas to communicate with the base station and to communicate with the one or more peer stations; and
a touch screen to receive input from a user.
